(19) United States
(12) Patent Application Publication
(10) Pub. No.: US 2008/0045260 A1
(43) Pub. Date: Feb. 21, 2008

(54) Power Settings for the Sounding Reference signal and the Scheduled Transmission in Multi-Channel Scheduled Systems

(76) Inventors: Tarik Muharemovic, Dallas, TX (US); Zukang Shen, Richardson, TX (US)

Correspondence Address: TEXAS INSTRUMENTS INCORPORATED, P O BOX 655474, M/S 3999, DALLAS, TX, 75265, US

(21) Appl. No.: 11/839,460

(22) Filed: Aug. 15, 2007

Related U.S. Application Data
(60) Provisional application No. 60/822,445, filed on Aug. 15, 2006.
(60) Provisional application No. 60/822,695, filed on Aug. 17, 2006.

(51) Int. Cl. H04Q 7/20; H04B 7/00

(52) U.S. Cl. 455/522

(57) ABSTRACT

Scheduled transmissions in a multi-channel scheduled communication system include both sounding reference signal and data transmission in sub-frames. The sounding reference signal is transmitted from a user equipment device to a base station with a power level that is either open loop controlled or closed loop controlled by the base station and/or the network. The transmit power level for the sounding reference signal can be a constant or a function of the number of scheduled channels for data transmission. The base station informs the UE the number of scheduled channels, as well as a data transmit power offset relative to the sound reference signal power. The data transmit power level is decided according to the sounding reference signal transmit power, the allocated channels, and the data transmit power offset.

### CLAIM OF PRIORITY UNDER 35 U.S.C. 119(e)

The present application for patent claims priority to U.S. Provisional Application No. 60/822,445 entitled “Per User Uplink Closed Loop Power Control with Inter-NodeB Power Control Information Exchange” filed Aug. 15, 2006, incorporated by reference herein. The present application for patent also claims priority to U.S. Provisional Application No. 60/822,695 entitled “Power Settings for the Sounding pilot and the Scheduled Transmission in Multi-Channel Scheduled Systems” filed Aug. 17, 2006, incorporated by reference herein.

This application is related to Application number Ser. No. ______ (docket number TI-63198) filed on Aug. 15, 2007 entitled “Cellular Uplink Power Control with Inter-NodeB Power Control Information Exchange.”

### FIELD OF THE INVENTION

This invention generally relates to cellular communication systems, and in particular to controlling uplink power.

### BACKGROUND OF THE INVENTION

The Global System for Mobile Communications (GSM: originally from Groupe Special Mobile) is currently the most popular standard for mobile phones in the world and is referred to as a 2G (second generation) system. Universal Mobile Telecommunications System (UMTS) is one of the third-generation (3G) mobile phone technologies. Currently, the most common form uses W-CDMA (Wideband Code Division Multiple Access) as the underlying air interface. W-CDMA is the higher speed transmission protocol designed as a replacement for the aging 2G GSM networks deployed worldwide. More technically, W-CDMA is a wideband spread-spectrum mobile air interface that utilizes the direct sequence Code Division Multiple Access signaling method (or CDMA) to achieve higher speeds and support more users compared to the older TDMA (Time Division Multiple Access) signaling method of GSM networks.

Orthogonal Frequency Division Multiple Access (OFDMA) is a multi-user version of the popular Orthogonal Frequency-Division Multiplexing (OFDM) digital modulation scheme. Multiple access is achieved in OFDMA by assigning subsets of subcarriers to individual users. This allows simultaneous transmission from several users. Based on feedback information about the channel conditions, adaptive user-to-subcarrier assignment can be achieved. If the assignment is done sufficiently fast, this further improves the OFDM robustness to fast fading and narrow-band cochannel interference, and makes it possible to achieve even better system spectral efficiency. Different number of sub-carriers can be assigned to different users, in view to support differentiated Quality of Service (QoS), i.e. to control the data rate and error probability individually for each user. OFDMA is used in the mobility mode of IEEE 802.16 WirelessMAN Air Interface standard, commonly referred to as WiMAX. OFDMA is currently a working assumption in 3GPP Long Term Evolution downlink, named High Speed OFDM Packet Access (HSOPA). Also, OFDMA is the candidate access method for the IEEE 802.22 “Wireless Regional Area Networks”.

NodeB is a term used in UMTS to denote the BTS (base transceiver station). In contrast with GSM base stations, NodeB uses WCDMA or OFDMA as air transport technology, depending on the type of network. As in all cellular systems, such as UMTS and GSM, NodeB contains radio frequency transmitter(s) and the receiver(s) used to communicate directly with the mobiles, which move freely around it. In this type of cellular networks the mobiles cannot communicate directly with each other but have to communicate with the BTSs

Traditionally, the NodeBs have minimum functionality, and are controlled by an RNC (Radio Network Controller). However, this is changing with the emergence of High Speed Downlink Packet Access (HSDPA), where some logic (e.g. retransmission) is handled on the NodeB for lower response times.

The utilization of WCDMA and OFDMA technology allows cells belonging to the same or different NodeBs and even controlled by different RNC to overlap and still use the same frequency (in fact, the whole network can be implemented with just one frequency pair). The effect is utilized in soft handovers.

Since WCDMA and OFDMA often operates at higher frequencies than GSM, the cell range is considerably smaller compared to GSM cells, and, unlike in GSM, the cells' size is not constant (a phenomenon known as “cell breathing”). This requires a larger number of NodeBs and careful planning in 3G (UMTS) networks. Power requirements on NodeBs and UE (user equipment) are much lower.

A NodeB can serve several cells, also called sectors, depending on the configuration and type of antenna. Common configuration include omni cell (360°), 3 sectors (3×120°) or 6 sectors (3 sectors 120° wide overlapping with 3 sectors of different frequency).

High Speed Uplink Packet Access (HSUPA) is a packet-based data service of Universal Mobile Telecommunication Services (UMTS) with typical data transmission capacity of a few megabits per second, thus enabling the use of symmetric high-speed data services, such as video conferencing, between user equipment and a network infrastructure.

An uplink data transfer mechanism in the HSUPA is provided by physical HSUPA channels, such as an Enhanced Dedicated Physical Data Channel (E-DPDCH), implemented on top of the uplink physical data channels such as a Dedicated Physical Control Channel (DPCCH) and a Dedicated Physical Data Channel (DPDCH), thus sharing radio resources, such as power resources, with the uplink physical data channels. The sharing of the radio resources results in inflexibility in radio resource allocation to the physical HSUPA channels and the physical data channels.

The signals from different users within the same cell interfere with one another. This type of interference is known as the intra-cell interference. In addition, the base station also receives the interference from the users transmitting in neighboring cells. This is known as the inter-cell interference

Uplink power control is typically intended to control the received signal power from the active user equipments (UEs) to the base as well as the rise-over-thermal (RoT), which is a measure of the total interference (intra- and inter-cell) relative to the thermal noise. In systems such as HSUPA, fast power control is required due to the fast fluctuation in multi-user (intra-cell) interference, as well as in UEs' short term channel fading. This fast fluctuation will otherwise result in the well-known near-far problem. Moreover, as uplink transmission in an HSUPA system is not orthogonal, the signal from each transmitting UE is subject to interference from another transmitting UE. If the signal strength of UEs varies substantially, a stronger UE (for example, a UE in favorable channel conditions experiencing a power boost due to constructive short term channel fading such as Rayleigh fading) may completely overwhelm the signal of a weaker UE (with signal experiencing attenuation due to short term fading). To mitigate this problem, fast power control has been considered previously in the art where fast power control commands are transmitted from a base station to each UE to set the power of uplink transmission. As the objective of these power control commands is to combat short term channel fading for typical UE speeds and carrier frequencies in the order of 1 GHz, their transmission rate is in the order of 1 millisecond. This is also typically the order of a transmission time interval. In addition to this fast power control (a.k.a. inner loop power control), a slow power control (a.k.a. outer loop power control) is implemented to ensure that each of the user dedicated channels and other uplink control channels have sufficient Ec/Nt (chip SNR) for demodulation (see TR25.896 of 3rd Generation Partnership Project (3GPP) for HSUPA)

When an orthogonal multiple access scheme such as Single-Carrier Frequency Division Multiple Access (SC-FDMA)—which includes interleaved and localized Frequency Division Multiple Access (FDMA) or Orthogonal Frequency Division Multiple Access (OFDMA)—is used; multi-user interference is not present for low mobility and small for moderate mobility. This is the case for the next generation UMTS enhanced-UTRA (E-UTRA) system—which employs SC-FDMA—as well as IEEE 802.16e also known as Worldwide Interoperability for Microwave Access (WiMAX)—which employs OFDMA. In this case, the fluctuation in the total interference only comes from inter-cell interference and thermal noise. While fast power control can be utilized, it can be argued that its advantage is minimal. Hence, slow power control is more critical for orthogonal multiple access schemes.

### SUMMARY OF THE INVENTION

An embodiment of the present invention controls power levels of scheduled transmissions through the control of the power of a sounding reference signal (SRS), and also through separate control of a power spectral density (PSD) offset for scheduled transmissions. The PSD offset for scheduled transmissions is defined relative to the PSD of the SRS transmission. The SRS is transmitted from a user equipment device to a base station with a power level that is either open loop controlled or closed loop controlled by the serving site and/or the network. A serving site informs the UE about the scheduled channels, as well as a transmit PSD offset on scheduled channels relative to the SRS PSD. Transmit power of scheduled transmissions is decided according to the SRS transmit PSD, the allocated channels, and the PSD offset relative to SRS PSD.

### BRIEF DESCRIPTION OF THE DRAWINGS

Particular embodiments in accordance with the invention will now be described, by way of example only, and with reference to the accompanying drawings:

FIG. 1 is a representation of two cells in a cellular communication network that includes an embodiment of closed loop power control;

FIG. 2 is a flow diagram illustrating the closed loop power control method used in the network of FIG. 1;

FIG. 3 is a plot of scheduled transmissions illustrating transmission by a user device in the network of FIG. 1, including the transmission of a sounding reference signal as well as scheduled transmissions;

FIG. 4 is a flow diagram illustrating the control of the transmit power of sounding reference signal, as well as the setting of the transmit power of scheduled transmissions; and

FIG. 5 is a block diagram of a mobile user device for use in the network of FIG. 1.

### DETAILED DESCRIPTION OF EMBODIMENTS OF THE INVENTION

Conventional power control mechanisms do not employ information exchange between multiple cellular sites, and thus, are unable to effectively control interference which individual UEs generate to neighboring cell sites. In contrast, embodiments of the power control method described herein allow an effective control of inter-cell interference by employing power control information exchange between cellular sites. Consequently, cell interior users can transmit at higher power levels, provided they do not cause too much interference in the neighboring cells. Level of interference generated by each non-serving UE is monitored by the neighboring cell sites, upon which a power control assessment is communicated to the serving cell of the UE. Thus, the present power control method can achieve much better overall system spectral efficiency than the conventional power control method.

Note that a serving cell site is defined as the cell site which controls the transmission of a UE. Consequently, this UE is said to be a serving UE of that cell site. A non-serving cell site of a UE is defined to be a cell site that does not directly control the transmission of the UE. Moreover, closed loop power control is defined as a power control mechanism in which explicit power control commands are issued from a serving cell site to its serving UEs to control their transmission power levels. Open loop power control schemes adjust the power control parameters at either a cell site or UE, without explicit power control commands from a serving cell site to its serving UEs.

An exemplary embodiment of the power control invention for a particular UE, say UE “m,” is as follows. Each non-serving cell site, say cell-site “k,” measures the received signal strength “y[m,k]” from that UE, provided that it is able to perform such measurement. This measurement can be based on knowledge of adjacent UEs signature codes, or can be based on channels which are used by the said UE “m.” Said measurement and monitoring of the received signal strength can be on a long term basis, or on a short term basis. Each non-serving cell-site computes the power control assessment, for the said UE “m.” In general, the assessment “z[m,k]” can be any function of the measured “y[m,k].” For example, the said assessment can be in a form of suggested transmit power adjustment for that particular UE. In this case, the power assessment can be computed as follows

z[m,k]=x[m,k]−y[m,k]. (1)

Here, the formula is in logarithmic [dB] scale, and x[m,k] is the target signal strength for that particular non-serving UE, in the “k-th” cell site. Note that it is permissible that x[m,k] assumes one common value for all non-served mobiles, and that it is also possible that x[m,k] is determined and signaled to the cell-site by the cellular network. Furthermore, it is possible that “m” represents a group of UEs. It is important to note that the calculation of assessment given in (1) is just exemplary. Other forms of assessment calculations are possible, which involve processing of the measured received signal strength y[m,k]. For example, the power assessment z[m,k] for UE “m” from non-serving cell site “k” can be a function of the aggregate interference level at the non-serving cell site “k”, which in turn is a function of the measured received signal strength y[m,k] from all non-serving UEs.

Each non-serving cell-site “k” communicates the power assessment z[m,k] to other cell sites, preferably neighboring ones, through backhaul networks between cell sites. The backhaul network is defined as the network that allows direct wireline or wireless communication between a plurality of cell sites in the system. At least, the power assessment z[m,k] should be communicated to the serving site of user “m.” The serving site, say site “n”, receives power assessments z[m,k], where “k” belongs to the set of non-serving sites, which had sent the power assessments. Let this set be denoted by G[m]. It is important to note that the communication of the assessment can be explicit or implicit. For example, the explicit assessment would involve an identification “m” of the mobile for which the assessment is being made. The implicit assessment can involve identification of resources (codes, channels, etc) which the mobile “m” has used previously, during the measurements. Both explicit and implicit assessments can involve both value of the assessment and the identification of the mobile or the used resource.

In one exemplary embodiment, the serving site “n” combines all received power assessments z[m,k], for user “m,” to reach an external composite power assessment, denoted as z[m]. Subsequently, the serving site also uses its own assessment z[m,n], combined with the said external composite power assessment z[m], to compute the power control command for the UE “m,” denoted as C[m].

An exemplary definition of the external composite power assessment is

Z[m]=min_{kεG[m]}{z[m,k]}. (2)

where G[m] is the set of non-serving cell sites that sent power assessment on UE “m” to its serving site “n.” This means that the external composite power assessment is equal to the minimum of all available power assessments for that UE from non-serving cell sites. Note that if G[m] is an empty set, a default value for Z[m], denoted as Z_{default}, can be assumed. This default value Z_{default} should be optimized for system performance.

The serving cell site “n” measures the received signal strength “y[m,n]” (in dB scale) from UE “m.” This measurement can be performed on a long term basis or on a short term basis. Further, the said measurement can be based the signature codes of UE “m” or the resources (channels, codes, etc.) that UE “m” used.

With the external composite power assessment z[m] and the measured received signal strength y[m,n] from UE “m” at its serving cell site “n,” the serving site combines y[m,n] and Z[m] to a power control command C[m], which is subsequently sent to UE “m”, as follows:

C[m]=Z[m], if y[m,n]+Z[m]>=T[m,n]

C[m]=T[m,n]−y[m,n], if y[m,n]+Z[m]<T[m,n] (3)

where T[m,n] is the required received signal strength (in dB scale) for UE “m” at its serving site “n.” It is important to note that it is permissible that T[m,n] assumes one common value for all UEs, and that it is also possible that T[m,n] is determined and signaled to the cell sites by the network. Essentially, with the power control command determined in equation (3), the external composite power assessment is taken as the power control command provided that UE “m” meets (or exceeds) the required received signal strength at its serving cite “n”. Otherwise, the external composite power assessment is ignored and the power control command is set simply to meet the required receive signal strength at the serving site “n.”

It is important to note that the definition of external composite power assessment in equation (2) and the definition of power control command in equation (3) are both exemplary. Other calculations of external composite power assessment and power control command are possible. In general, the calculation of the power control command for UE “m” involves the power assessments on UE “m” from non-serving sites, the measurement on UE “m” at its serving site, and a certain requirement (e.g. received signal strength) on the signal quality of UE “m” at its serving site. Moreover, in case where the network imposes transmit power limitations on the UE, the calculation of the power control command also involves the transmit power limitation, e.g, a maximum transmit power limit Pₘₐₓ[m] (in dB scale) and/or a minimum UE transmit power limit Pₘᵢₙ[m] (in dB scale), for the UE m. In such case, an exemplary power control command calculation can be as follows

C[m]=max{min{P[m]+Z[m], Pₘₐₓ[m]}, Pₘᵢₙ[m]}−P[m], if y[m,n]+Z[m]>=T[m,n]

C[m]=max{min{P[m]+T[m,n]−y[m,n], Pₘₐₓ[m]}, Pₘᵢₙ[m]}−P[m], if y[m,n]+Z[m]<T[m,n] (4)

where P[m] is current transmit power of UE “m” in dB scale.

It is important to note that the transmit power limitations can be a set of UE specific values, or a set of UE class specific values. It is also typical that the transmit power limitations are a set of common values applicable to all UEs in the networks.

The said derived power control command C[m] is transmitted to UE “m,” typically from its serving site. In case a power control command is UE specific, it is transmitted in UE specific downlink channel. In case a power control command applies to a group of UEs, it is transmitted in some downlink channel that is readable by the group of UEs. An extreme case of this is that all UEs in a cell cite is one UE group that a common power control command applies to. Alternatively, all power control commands can be transmitted in a common downlink channel that is readable by all UEs served in a cell site, irrespective of UE specific or UE group specific power control commands.

All communications between various network entities in the above scheme takes part with quantized versions of following quantities: power assessment (z[m,k]) between cell sites, and the power control command (C[m]) between the serving cell site and the UE. In addition, the values which are possibly signaled by the network (Pₘᵢₙ[m], Pₘₐₓ[m], T[m,n], X[m,k]) can also be quantized. Various embodiments may use quantization methods optimized for a particular embodiment applied to the above parameters. For example, it is possible to quantize the power control commands C[m] as a single bit value (i.e. up vs. down by a pre-determined amount in dB scale). Also, it is possible to quantize the power assessment z[m,k] as a single bit value (i.e. up vs. down by a pre-determined amount in dB scale). Other quantization methods are not precluded.

To reduce the signaling overhead due to power assessment information exchange between cell sites, it is not precluded that each cell site only communicates a subset of its power assessments on a subset of monitored non-serving UEs to their serving cell sites. Alternatively, each cell site can communicate only the “power down” assessment on a subset of the monitored non-serving UEs to their serving cell sites. Other mechanisms to reduce the inter-site information exchange overhead are not precluded.

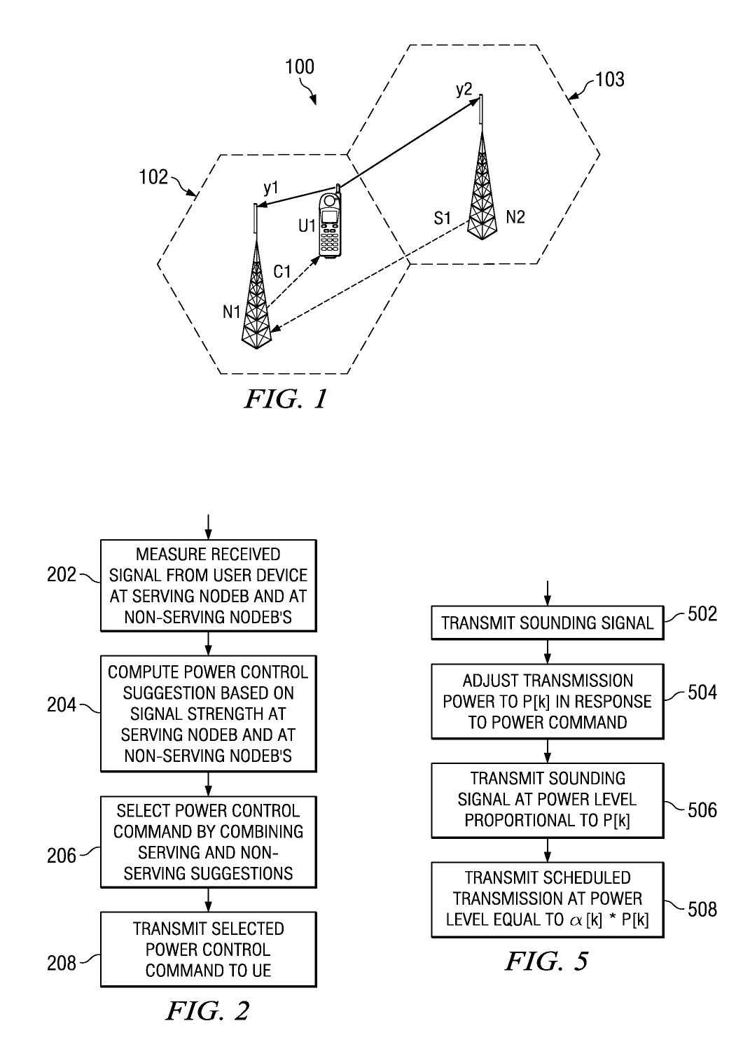

FIG. 1 is a representation of two cells in a cellular communication network 100 that includes an embodiment of the closed loop power control method. In this representation only two cells 102-103 are illustrated for simplicity, but it should be understood that the network includes a large matrix of cells and each cell is generally completely surrounded by neighboring cells. User equipment U1 is currently in cell 102 and is being served by cell site N1. Cell 103 is a neighbor cell and the cell site N2 is not serving UE U1. In this embodiment of closed loop power control, both N1 and N2 monitor the received signal strength from U1, denoted as y1 and y2, respectively. The non-serving cell site N2 generates a power assessment on UE U1, and communicates the power assessment to the serving site of UE U1, i.e. cell site N1, via an inter-cell communication link S1. Subsequently, the serving site N1 combines its own signal strength measurement on UE U1 with available power control assessments from the neighbors to obtain a power control command for UE U1. Finally, the serving cell site issues the power control command to that particular served UE by transmitting message C1 in downlink channels.

FIG. 2 is a flow diagram illustrating the closed loop power control method used in network 100. A signal from the particular UE is monitored 202 by its serving cell site and also by non-serving neighbor cell sites. Depending on cell layout, topography, obstructing objects, etc, not every neighbor of a given serving cell site will be able to measure signals from a particular UE.

Based on the measured signal strength from a UE, both the non-serving cell sites and the serving cell site compute 204 power assessments on the particular UE.

The neighboring non-serving cell sites communicate 206 the power assessments on the particular UE to its serving cell site through inter-cell communication networks.

Upon receiving power assessments on a particular UE from neighboring non-serving cell sites, the serving cell site combines 208 the available power assessments from non-serving cell sites, together with its own measurement of the received signal strength of that particular UE. From this combination, the serving cell site obtains 208 a power control command for that particular UE and transmits 210 the power control command to that UE.

In high data rate communication systems, the resources are typically divided into a number of parallel channels, where a channel can be a subset of resources determined by any available resource partitioning schemes. For example, each channel can consist of a set of sub-carriers, for frequency division multiplex transmission. Based on UE channel conditions as well as UE traffic properties, a scheduler in each cell site schedules a subset of UEs for transmission on available channels, as well as the modulation and coding scheme (MCS) each scheduled UE should employ on its scheduled channels.

In this embodiment, the system time is partitioned into scheduling periods, which are often called sub-frames. In this disclosure the term “sub-frame” is uses as a synonym to the scheduling period in a scheduled transmission system. The scheduling period or sub-frame can be defined as the time interval between consecutive scheduling decisions made by the scheduler.

Each UE transmits a sounding reference signal (SRS), in order to provide channel condition estimation at the cell site (among other purposes). In this embodiment, SRS can span all available channels in the system to provide maximum diversity gain. It is not precluded that SRS can span a subset of available channels in the system. Further, in this embodiment, SRS is sent every scheduling period. It is not precluded that in other embodiments, SRS may be sent more or less frequently.

An embodiment of the present invention is that the power of scheduled transmission is controlled through the control of the SRS power, and a separate control of the power spectral density (PSD) offset for scheduled transmissions. The power spectral density can be defined as the total transmission power per frequency unit. Denote Pₛᵣₛ[m] as the total SRS transmission power of UE “m” across all available “N” frequency channels in the system. In linear scale, the SRS PSD (i.e. SRS transmission power per channel) can be defined as

PSDₛᵣₛ[m]=Pₛᵣₛ[m]/N (5)

The SRS transmit power can be controlled by any open loop or closed loop power control mechanisms. In one embodiment, the SRS transmit power Pₛᵣₛ[m] of UE “m” is controlled by the earlier described power control method. The SRS transmit power of UE “m” remains constant across consecutive sub-frames, unless it is updated by a power control command from the serving site. In most embodiments, the power control commands on the transmit power of SRS are issued at a much lower rate than the scheduling period. For example, the power control mechanism on SRS may require a UE to update the transmit power of SRS on the order of tens of sub-frames.

With the PSD of SRS defined in (5), in linear scale, the PSD of scheduled transmission of UE “m” on each scheduled channel can be defined as

PSD_{data}[m]=α[m]*PSDₛᵣₛ[m] (6)

where α[m] is the PSD offset for scheduled transmission of UE “m” relative to the PSD of SRS of that UE. α[m] can be a UE specific value, or a UE group specific value, or a common value applied to all UEs in the cell cite.

The PSD offset “α[m]” for UE “m” can be dynamically adjusted, and revealed to UE “m” via slower-rate higher layer signaling or through dedicated downlink channels. Alternatively, other embodiments may include scenarios where a[m] is fixed to some pre-determined value, for example, a[m]=1. In addition, the scheduler at cell site is aware of the exact value of “a[m]”, because “α[m]” is a piece of necessary information for the scheduler to determine the supportable MCS of UE “m” on the available channels.

In linear scale, the total power of scheduled transmission P_{data}[m] of UE “m” can be calculated as

P_{data}[m]=PSD_{data}[m]*n[m] (7)

where n[m] is the number of currently scheduled channels for UE “m.” It is important to note that prior to the scheduled transmission in the current sub-frame, the scheduling decision must be conveyed through downlink channels to any UE that are scheduled for transmission in the current sub-frame. Consequently, n[m] is known at UE “m.”

It is important to note that the relationship between the power of scheduled transmission to the power of SRS in equations (5)-(7) is exemplary. In general, the power of the scheduled transmission can be a function of the power of the SRS, the scaling factor of the PSD of scheduled transmission relative to the SRS PSD, and the scheduled channels. The power of SRS or the PSD of SRS can be controlled by any open loop or closed loop power control mechanisms. Furthermore, the scaling factor of the PSD of scheduled transmission relative to the SRS PSD can be a function of the scheduled MCS on scheduled channels. For example, in Orthogonal Frequency Division Multiple Access (OFDMA) or Single Carrier Orthogonal Frequency Division Multiple Access (SC-OFDMA) systems, the MCS on the scheduled channels can be the different (in OFDMA) or the same (in SC-OFDMA). The scheduled MCS as well as the scheduled channels are communicated to each scheduled UE through downlink channels.

The scaling factor of the PSD of scheduled transmission relative to the SRS PSD can be explicitly signaled to each scheduled UE via downlink channels, or each scheduled UE can implicitly derive the scaling factor with the scheduling information (e.g. the scheduled MCS on the scheduled channels) conveyed through downlink channels. In one embodiment, the scaling factor can be a common value applied on all scheduled channels. In other embodiments, the scaling factor can be a channel-dependent value.

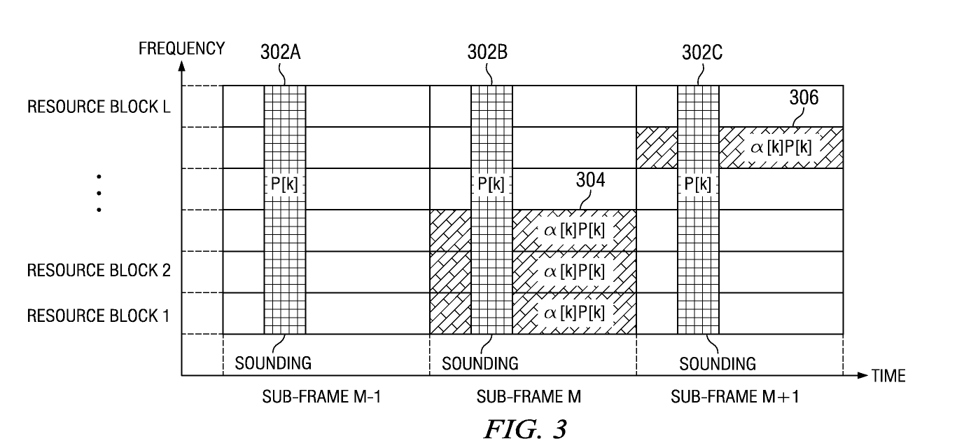

FIG. 3 is a plot illustrating the transmission of SRS as well as the scheduled transmissions by a user device in network 100. Embodiments of the present invention may apply to both uplink (multi-user) and downlink transmission. An uplink scheme is described herein, but a downlink scheme using the same principles can be embodied in a similar manner.

Referring still to FIG. 3, an example of a portion of a transmission from one UE to a cell site is illustrated. As described above, UE “m” keeps sending the sounding reference signal 302A-302C with power Pₛᵣₛ[m] across a number (say N) of channels for each sub-frame. In sub-frame M−1 no scheduled transmission is present from this UE, because other UEs are scheduled. In sub-frame M, UE “m” is awarded three channels 304 for scheduled transmission and therefore total transmit power for scheduled transmission is 3α[m]Pₛᵣₛ[m]/N, whereas the SRS is still sent with the transmit power Pₛᵣₛ[m]. In sub-frame M+1, UE “m” is awarded one channel 306 and the UE sends the SRS with power Pₛᵣₛ[m], and scheduled transmission with α[m]Pₛᵣₛ[m]/N.

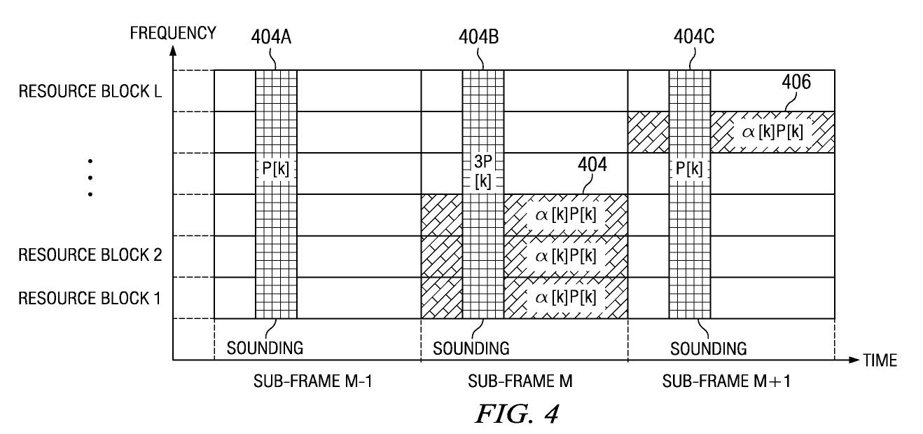

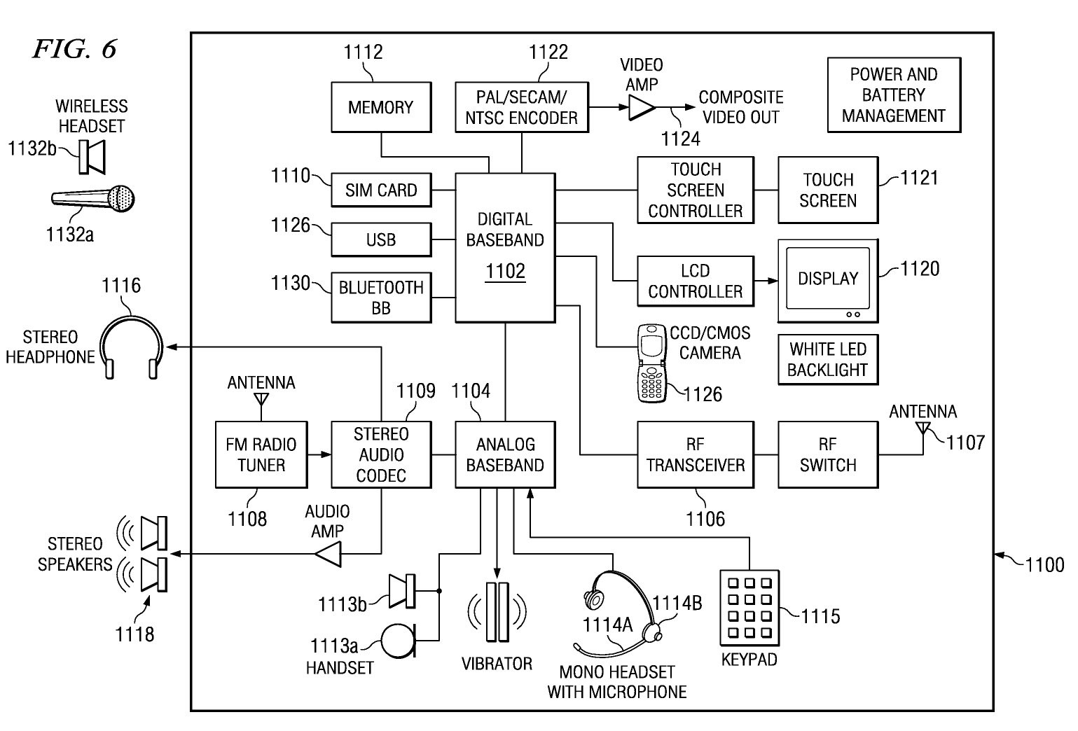

FIG. 4 is a flow diagram illustrating the control of the transmit power of SRS as well as the setting of the transmit power of scheduled transmissions. Each UE transmits 402 a sounding reference signal. The network, potentially involving both serving and non-serving cell sites of the UE, controls 404 the transmit power of the sounding reference signal of the UE. Upon receiving the power control command on SRS, the UE transmits 406 the SRS at power level according to the received power control command. It is important to note that it is not necessary for a UE to update its SRS transmit power, unless it receives a power control command on SRS. According to the SRS transmit power, a PSD offset of scheduled transmission relative to the PSD of SRS, as well as scheduling information, the UE derives 408 the power of scheduled transmission and transmits 410 the scheduled transmission at the derived power level.

In one embodiment, the transmit power of SRS is controlled by the described power control method in this invention. Each cell site monitors the received SRS signal strength from non-serving UEs. In this case, the SRS can be regarded as the signature code of each UE. After measuring the received SRS signal strength at a cell site, a power assessment can be evaluated at the cell site and subsequently communicated to the serving site of the UE. The serving site combines the power assessments on its serving UE's SRS transmit power from neighboring cell sites, as well as its own measurement of the received SRS signal strength from the serving UE, to obtain a proper power control command, which is issued to the serving UE via downlink channels. After receiving the power control command on SRS, the UE updates the transmit power of SRS. Consequently, the UE's transmit power of its scheduled transmission on scheduled channels is adjusted as well, based on the updated power of SRS, the PSD offset of scheduled transmission relative to the PSD of SRS, as well as the scheduling information, which includes but not limited to the scheduled channels and the supportable MCS on the scheduled channels.

FIG. 9 is a block diagram of another digital system 1100 with an embodiment of transmitter level power control, as described above. Digital system 1100 a representative cell phone that is used by a mobile user. Digital baseband (DBB) unit 1102 is a digital processing processor system that includes embedded memory and security features. In this embodiment, DBB 1102 is an open media access platform (OMAP™) available from Texas Instruments designed for multimedia applications. Some of the processors in the OMAP family contain a dual-core architecture consisting of both a general-purpose host ARM™ (advanced RISC (reduced instruction set processor) machine) processor and one or more DSP (digital signal processor). The digital signal processor featured is commonly one or another variant of the Texas Instruments TMS320 series of DSPs. The ARM architecture is a 32-bit RISC processor architecture that is widely used in a number of embedded designs.

Analog baseband (ABB) unit 1104 performs processing on audio data received from stereo audio codec (coder/decoder) 1109. Audio codec 1109 receives an audio stream from FM Radio tuner 1108 and sends an audio stream to stereo headset 1116 and/or stereo speakers 1118. In other embodiments, there may be other sources of an audio stream, such a compact disc (CD) player, a solid state memory module, etc. ABB 1104 receives a voice data stream from handset microphone 1113a and sends a voice data stream to handset mono speaker 1113b. ABB 1104 also receives a voice data stream from microphone 1114a and sends a voice data stream to mono headset 1114b. Usually, ABB and DBB are separate ICs. In most embodiments, ABB does not embed a programmable processor core, but performs processing based on configuration of audio paths, filters, gains, etc being setup by software running on the DBB. In an alternate embodiment, ABB processing is performed on the same OMAP processor that performs DBB processing. In another embodiment, a separate DSP or other type of processor performs ABB processing.

RF transceiver 1106 includes a receiver for receiving a stream of coded data frames from a cellular base station via antenna 1107 and a transmitter for transmitting a stream of coded data frames to the cellular base station via antenna 1107. A sounding reference signal is transmitted by a UE to the base stations and power control commands are received from the serving base station as described above. Transmission of the sounding reference signal and the scheduled transmissions are performed using power levels as described above. In this embodiment, a single transceiver supports both GSM and WCDMA operation but other embodiments may use multiple transceivers for different transmission standards. Other embodiments may have transceivers for a later developed transmission standard with appropriate configuration. RF transceiver 1106 is connected to DBB 1102 which provides processing of the frames of encoded data being received and transmitted by cell phone 1100.

The basic WCDMA DSP radio consists of control and data channels, rake energy correlations, path selection, rake decoding, and radio feedback. Interference estimation and path selection is performed by instructions stored in memory 1112 and executed by DBB 1102 in response to signals received by transceiver 1106.

DBB unit 1102 may send or receive data to various devices connected to USB (universal serial bus) port 1126. DBB 1102 is connected to SIM (subscriber identity module) card 1110 and stores and retrieves information used for making calls via the cellular system. DBB 1102 is also connected to memory 1112 that augments the onboard memory and is used for various processing needs. DBB 1102 is connected to Bluetooth baseband unit 1130 for wireless connection to a microphone 1132a and headset 1132b for sending and receiving voice data.

DBB 1102 is also connected to display 1120 and sends information to it for interaction with a user of cell phone 1100 during a call process. Display 1120 may also display pictures received from the cellular network, from a local camera 1126, or from other sources such as USB 1126.

DBB 1102 may also send a video stream to display 1120 that is received from various sources such as the cellular network via RF transceiver 1106 or camera 1126. DBB 1102 may also send a video stream to an external video display unit via encoder 1122 over composite output terminal 1124. Encoder 1122 provides encoding according to PAL/SECAM/NTSC video standards.

As used herein, the terms “applied,” “connected,” and “connection” mean electrically connected, including where additional elements may be in the electrical connection path. “Associated” means a controlling relationship, such as a memory resource that is controlled by an associated port. The terms assert, assertion, de-assert, de-assertion, negate and negation are used to avoid confusion when dealing with a mixture of active high and active low signals. Assert and assertion are used to indicate that a signal is rendered active, or logically true. De-assert, de-assertion, negate, and negation are used to indicate that a signal is rendered inactive, or logically false.

While the invention has been described with reference to illustrative embodiments, this description is not intended to be construed in a limiting sense. Various other embodiments of the invention will be apparent to persons skilled in the art upon reference to this description. This invention applies to all scheduled communication systems which perform power control and channel sounding across multiple resource blocks. This invention applies in uplink and downlink. The embodiments of this invention apply for all modulation strategies, which include but are not limited to, OFDMA, CDMA, DFT-spread FDMA, SC-OFDMA, and others. Embodiments of this invention can be applied in most if not all emerging wireless standards, including EUTRA.

Other embodiments of this invention may include other quantization schemes beyond the one bit scheme described herein. Any value associated with the closed loop power control method as described in this document can be quantized by any quantization method.

While a mobile user equipment device has been described, embodiments of the invention are not limited to mobile devices. Desktop equipment and other stationary equipment being served by a cellular network will also participate in the power control methods described herein.

It is therefore contemplated that the appended claims will cover any such modifications of the embodiments as fall within the true scope and spirit of the invention.

What is claimed is:

1. A method for setting the transmission power of scheduled transmissions in a wireless network, comprising:
transmitting from a user equipment (UE) a sounding reference signal (SRS) with an SRS transmission power across a plurality of frequency channels;
receiving a power spectrum density (PSD) offset value from the network at the UE, where the PSD offset is relative to SRS power spectrum density;
receiving allocated frequency channel indicia for a scheduled transmission from a serving cell site in the network at the UE; and
transmitting data from the UE with a transmission power that depends on the SRS transmission power, the allocated frequency channels, and the PSD offset value.

2. The method of claim 1, wherein the transmission of SRS spans a subset of available frequency channels.

3. The method of claim 1, wherein the transmission power of SRS is either open loop controlled or closed loop controlled by the network.

4. The method of claim 1, wherein the PSD offset of scheduled transmission relative to the PSD of SRS is channel-specific, and applies to at least one UE.

5. The method of claim 1, wherein the PSD offset of scheduled transmission relative to the PSD of SRS is explicitly signaled to each scheduled UE through higher layer signaling or via downlink channels.

6. The method of claim 1 further comprising:
communicating scheduling information from serving cell site to the UE through downlink channels; and
wherein the scheduled UE can implicitly derive the PSD offset by the UE based on the scheduling information, wherein the scheduling information includes information on scheduled frequency channels and supportable modulation and coding schemes on the scheduled channels.

7. The method of claim 1, further comprising deriving a PSD, comprising:
measuring a received signal strength for at least one user equipment (UE) in at least one non-serving cell site;
deriving a power assessment for the UE based on the received signal strength in the non-serving cell site;
communicating the power assessment to at least one other cell site;
deriving a local power assessment for the UE based on a measured received signal strength in the serving cell site;
receiving power assessments on the UE from one or more non-serving cell sites at the serving cell site;
deriving a power command by combining all or a subset of the received power assessments on the UE with the local power assessment on the UE; and
transmitting the derived power control command to the UE.

8. The method of claim 3, wherein he SRS transmission power of a UE remains unchanged, unless a power control command on the transmission power of SRS is received then upon receiving the power control command, the UE adjusts its SRS transmission power according to the received power control command.

9. The method of claim 6, wherein the total transmission power on scheduled frequency channels is a linear function of the PSD offset, a linear function of the number of scheduled frequency channels, or a linear function of the SRS transmission power.

10. A user equipment for scheduled transmissions in a wireless network, comprising:
means for transmitting from the user equipment (UE) a sounding reference signal (SRS) with an SRS transmission power across a plurality of frequency channels;
means for receiving a power spectrum density (PSD) offset value from the network at the UE, where the PSD offset is relative to SRS power spectrum density;
means for receiving allocated frequency channel indicia for a scheduled transmission from a serving cell site in the network at the UE; and
means for transmitting data from the mobile device with a transmission power that depends on the SRS transmission power, the allocated frequency channels, and the PSD offset value.

11. The user equipment of claim 10, further comprising means for implicitly deriving the PSD offset by the UE based on the scheduling information, wherein the scheduling information includes information on scheduled frequency channels and supportable modulation and coding schemes on the scheduled channels.

12. A user equipment(UE) comprising:
transmitter circuitry operable to transmit sounding reference (SRS) with an SRS transmission power across a plurality of frequency channels;
receiving circuitry operable to receive a power spectrum density (PSD) offset value from the network, where the PSD offset is relative to SRS power spectrum density and operable to receive allocated frequency channel indicia for a scheduled transmission;
processing circuitry connected to the transmitter circuitry and to the receiver circuitry operable to utilize the PSD and allocated frequency channel indicia to control the transmitter to transmit with a transmission power that depends on the SRS transmission power, the allocated frequency channels, and the PSD offset value.

13. A method for setting the transmission power of scheduled transmissions in a wireless network, comprising:
receiving from a user equipment (UE) a sounding reference signal (SRS) with an SRS transmission power across a plurality of frequency channels;
transmitting a power spectrum density (PSD) offset value from the network to the UE, where the PSD offset is relative to SRS power spectrum density;
transmitting allocated frequency channel indicia for a scheduled transmission from a serving cell site in the network to the UE; and
receiving data from the UE with a transmission power that depends on the SRS transmission power, the allocated frequency channels, and the PSD offset value.

14. The method of claim 13, wherein the reception of SRS spans a subset of available frequency channels.
